(19) United States
(12) Patent Application Publication
(10) Pub. No.: US 2011/0128131 A1
(43) Pub. Date: Jun. 2, 2011

(54) HEAD NODE SELECTION METHOD FOR CLUSTERING IN WIRELESS SENSOR NETWORK AND WIRELESS SENSOR NETWORK

(75) Inventors: Ki Seon KIM, Gwangju (KR); Jeong Hwan YOON, Gwangju (KR); Sae Woom LEE, Gwangju (KR)

(73) Assignee: Gwangju Institute of Science Technology, Gwangju (KR)

(21) Appl. No.: 12/955,721

(22) Filed: Nov. 29, 2010

(30) Foreign Application Priority Data
Dec. 2, 2009 (KR) 10-2009-0118547

(51) Int. Cl. G08B 9/00

(52) U.S. Cl. 340/286.02

(57) ABSTRACT

The present invention relates to a wireless sensor network, and more particularly, to a head node selection method for clustering in a wireless sensor network and a wireless sensor network. The wireless sensor network for determining a head node that includes: a first node; and a second node wirelessly being in communication with the first node, wherein the first node broadcasts a final head node message which is a message indicating that the first node itself is a final head node to the second node if the residual energy of the first node is larger than the residual energy of the neighboring nodes. It is therefore possible to minimize clustering process time.

### BACKGROUND OF THE INVENTION

1. Field of the Invention

The present invention relates to a wireless sensor network, and more particularly, to a head node selection method for clustering in a wireless sensor network and a wireless sensor network.

2. Description of the Related Art

A clustering method in a wireless sensor network can generally be classified into a distributed method and a centralized method.

The centralized method is limited to a large-scale network since a base station has the positional information of all nodes and processes all operations. In contrast, the distributed method is useful for applications such as the monitoring of an environment, an enemy, and the like in large areas because each sensor node independently operates without a help of the base station.

However, in the distributed method, since only information regarding a 1 hop neighboring node is used, clustering process time is comparatively short while limited information should be maximally utilized.

Further, the node cannot perform its normal operation while configuring the clustering process. Therefore, it is important to ensure the normal operating time while reducing the time required for the clustering process. The existing IEEE 802.15.4 Standard Working Group supports a cluster tree structure as one type of a network topology, but it does not clearly describe a standard specification and merely provides a simple routing for tree configuration.

Moreover, since the distribution method is primarily for a short-range communication, it is difficult to apply the method in large-scale networks.

### SUMMARY OF THE INVENTION

The present invention has been made in an effort to provide a head node selection method for minimizing a clustering process time in a distributed wireless sensor network suitable for a large-scale network and the wireless sensor network.

An exemplary embodiment of the present invention provides a method of determining a head node for clustering in a wireless sensor network constituted by a plurality of nodes, the method including: generating, by at least one node among the plurality of nodes, a neighboring node management table including residual energy of neighboring nodes by being in communication with the neighboring nodes; selecting, by the node, a node having the largest residual energy as a candidate head node from the neighboring node management table; determining, by the node, receiving a final head node message indicating that the node itself is a final head node from the candidate head node within a predetermined time; and determining the candidate head node as the final head node or a relay node on the basis of the determination result.

In addition, the determining may include: determining the candidate head node as the final head node when the final head node message is received from the candidate head node within the predetermined time; and determining the candidate head node as the relay node when the final head node message is not received from the candidate head node within the predetermined time.

Further, the neighboring node management table may include information about the neighboring node and information about its own residual energy.

The neighboring node management table may include information regarding the node itself and information regarding the node's own residual energy.

Another exemplary embodiment of the present invention provides a method of determining a head node for clustering in a wireless sensor network constituted by a plurality of nodes, the method including: acquiring, by a first node among the plurality of nodes, residual energy information of neighboring nodes by being in communication with the neighboring nodes; determining, by the first node, itself as a head node if the residual energy of the first node is larger than the residual energy of the neighboring node; and broadcasting, by the first node, a final head node message indicating that the first node itself is the head node to the neighboring nodes.

The method may further include determining, by the second node, the neighboring node having the largest residual energy as a final head node when a second node among the plurality of nodes receives the final head node message from a neighboring node having the largest residual energy within a predetermined time.

The method may further include determining, by the second node, the neighboring node having the largest residual energy as a relay node when the second node among the plurality of nodes does not receive the final head node message from the neighboring node having the largest residual energy within the predetermined time.

Yet another exemplary embodiment of the present invention provides a wireless sensor network that includes: a first node; and at least one neighboring node wirelessly being in communication with the first node, wherein the first node selects a node having the largest residual energy among the neighboring nodes as a candidate head node and determines the candidate head node as a final head node or a relay node by determining whether or not the first node receives a final head node message indicating that the candidate head node is the final head node from the candidate head node within a predetermined time.

The first node may determine the candidate head node as the final head node when the first node receives the final head node message from the candidate head node within the predetermined time and determine the candidate head node as the relay node when the first node does not receive the final head node message from the candidate head node within the predetermined time.

The first node may generate a neighboring node management table including the residual energy of the neighboring nodes by being in communication with the neighboring nodes.

Still another exemplary embodiment of the present invention provides a wireless sensor network that includes: a first node; and a second node wirelessly being in communication with the first node, wherein the first node broadcasts a final head node message which is a message indicating that the first node itself is a final head node to the second node if the residual energy of the first node is larger than the residual energy of the neighboring node.

The second node may determine the first node as the final head node when the second node receives the final head node message from the first node within a predetermined time.

The wireless sensor network may further include a third node wireless being in communication with the second node, wherein the third node determines that the second node is a node having the largest residual energy among neighboring nodes of the third node, but the third node determines the second node as a relay node when the third node does not receive the final head node message from the second node within a predetermined time.

According to the exemplary embodiments of the present invention, it is possible to minimize a clustering process time required to configure clustering by determining a head node. It is possible to ensure the time required for main operations such as actual monitoring, and the like in large-scale wireless sensor networks by saving the clustering process time to improve efficiency.

### BRIEF DESCRIPTION OF THE DRAWINGS

FIG. 1 is a diagram illustrating an example of one topology in a distributed wireless sensor network;

FIG. 2 is a diagram illustrating a communication range on the basis of Node 1 and Node 2 according to an exemplary embodiment of the present invention;

FIG. 3 is a neighboring node management table of Node 1 according to an exemplary embodiment of the present invention;

FIG. 4 is a neighboring node management table of Node 2 according to an exemplary embodiment of the present invention;

FIG. 5 is a neighboring node management table of Node 5 according to an exemplary embodiment of the present invention;

FIG. 6 is a diagram illustrating a cluster according to an exemplary embodiment of the present invention; and

FIG. 7 is a flowchart describing a method of determining a head node for clustering according to an exemplary embodiment of the present invention.

### DETAILED DESCRIPTION OF THE EMBODIMENTS

Hereinafter, exemplary embodiments of the present invention will be described with reference to the accompanying drawings. In referring to reference numerals to components of each drawing, the same components are referred by the same reference numerals as much as possible even if they are shown in different figures. Detailed descriptions of well-known techniques are omitted so as not to obscure the description of the present invention with unnecessary detail.

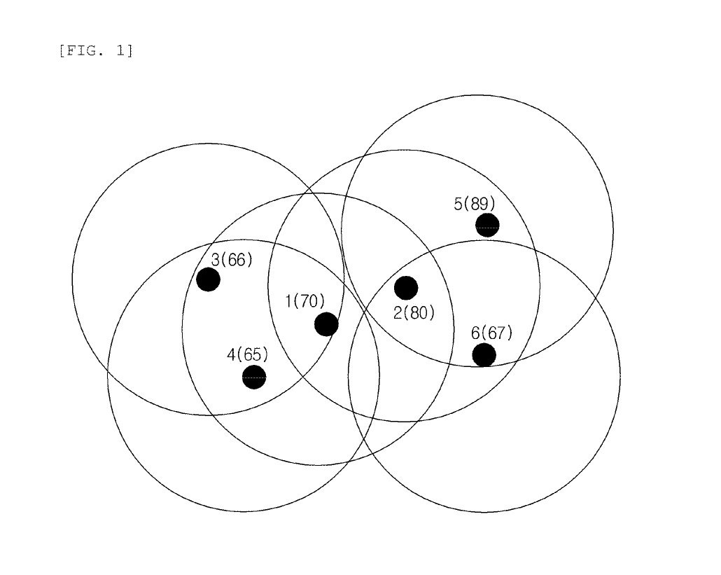

FIG. 1 is a diagram illustrating an example of one topology in a distributed wireless sensor network. As shown in FIG. 1, the distributed wireless sensor network includes a plurality of nodes and each node is in communication only within a predetermined range indicated by a solid line. A number adjacent to each node represents an address of the corresponding node and a number in parentheses represents a residual energy remaining in each node on the basis of 100 which is the maximum value.

Nodes other than each node which are positioned within the communication range are referred to as neighboring nodes. For example, neighboring nodes of Node 1 include Node 2, Node 3, and Node 4 and neighboring nodes of Node 2 includes Node 1, Node 5, and Node 6.

Each node performs communication for finding neighboring nodes to exchange residual energy information of the neighboring node. In addition, each node generates a neighboring node management table to obtain residual energy information of the nodes and selects a node having the largest residual energy as a candidate head node from the neighboring node management table. The candidate head node is the node having the largest residual energy. Therefore, the candidate head node may also be referred to as a locally maximum energy node (LMENODE).

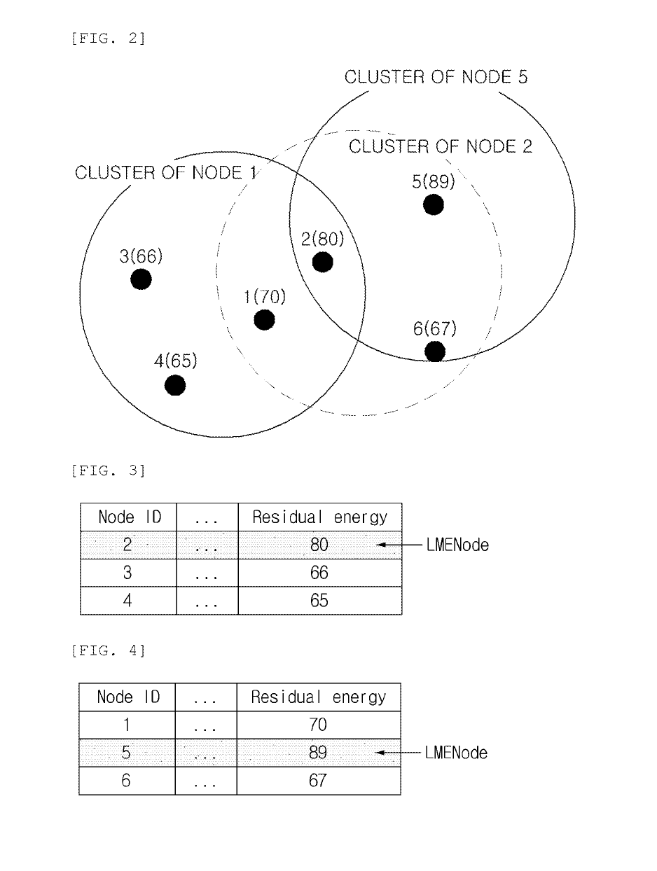

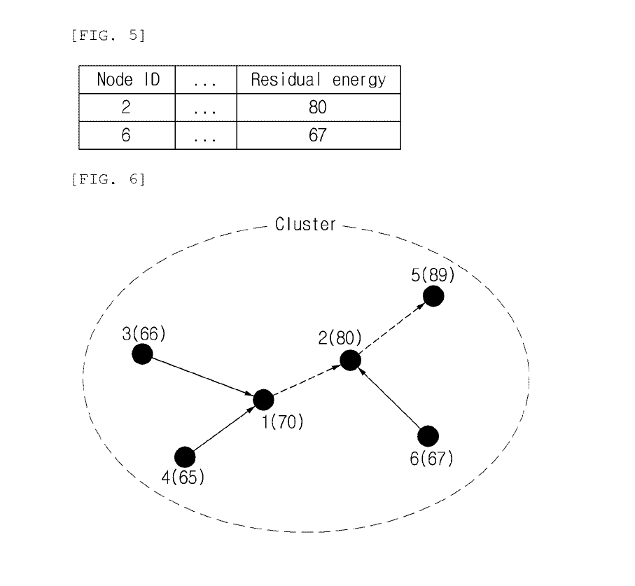

FIG. 2 is a diagram illustrating a communication range on the basis of Node 1 and Node 2 according to an exemplary embodiment of the present invention, FIG. 3 is a neighboring node management table of Node 1 according to an exemplary embodiment of the present invention, and FIG. 4 is a neighboring node management table of Node 2 according to an exemplary embodiment of the present invention. In addition, FIG. 5 is a neighboring node management table of Node 5 according to an exemplary embodiment of the present invention.

As shown in FIG. 2, Node 1 receives residual energy information of the neighboring nodes from Nodes 2 to 4 which are neighboring nodes within the communication range. In addition, as shown in FIG. 3, Node 1 generates a neighboring node management table including information regarding the nodes and the residual energy information of the nodes and selects a node having the largest residual energy as the candidate head node. Each node compares its own residual energy with the residual energy of the neighboring nodes at the time of selecting the candidate head node.

Node 1 selects Node 2 as the candidate head node from the neighboring node management table and Node 2 selects Node 5 as the candidate head node from the neighboring node management table of FIG. 4.

Meanwhile, Node 5 selects Node 2 as the candidate head node from the neighboring node management table. However, since the residual energy of the candidate head node is smaller than that of Node 5, Node 5 determines itself as a final head node.

Thereafter, Node 5 which is determined as the final head node broadcasts a message indicating that Node 5 itself is the final head node. The message indicating the final head node is referred to as a final head node message.

When each of the remaining nodes other than Node 5 receive a message indicating the final head node from the candidate head node selected by each node within a predetermined time, each node determines its own candidate head node as the final head node. However, when each node does not receive the message indicating the final head node from the candidate head node selected by each node within a predetermined time, each node determines its own candidate head node as a relay node. Herein, in general, the predetermined time is preferably a time for the message to reach each node.

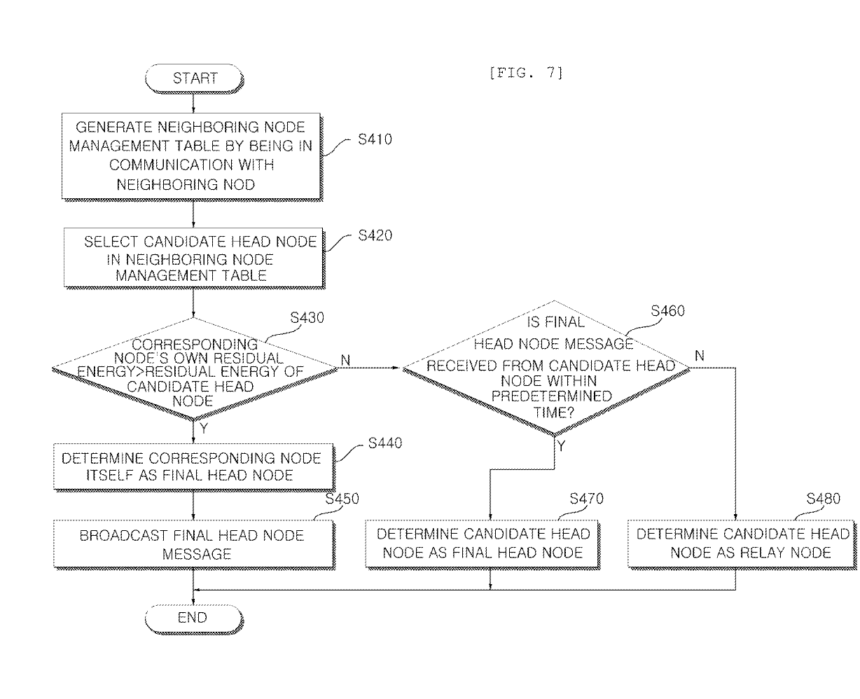

FIG. 6 is a diagram illustrating a cluster according to an exemplary embodiment of the present invention.

Nodes 3 and 4 select Node 1 as the candidate head node, Nodes 1 and 6 select Node 2 as the candidate head node, and Node 2 selects Node 5 as the candidate head node. Meanwhile, since the residual energy of Node 5 is larger than the residual energy of the neighboring node, Node 5 determines itself as the final head node. In addition, Node 5 broadcasts a message indicating that Node 5 itself is the final head node to Nodes 2 and 6.

Further, Nodes 1 to 4 and Node 6 verify whether the final head node message from the final head nodes has been received within a predetermined time. Node 2 receives the final head node message from Node 5 within a predetermined time. Therefore, Node 2 determines Node 5 as the final head node.

However, Node 1, Node 3, Node 4, and Node 6 do not receive the final head node messages from their own candidate head nodes within a predetermined time. Therefore, Node 1, Node 3, Node 4, and Node 6 determine their own candidate head nodes as the relay nodes.

Consequently, clustering using Node 5 as the head node is performed.

FIG. 7 is a flowchart describing a method of determining a head node for clustering according to an exemplary embodiment of the present invention.

A node communicates with a neighboring node to generate a neighboring node management table (S410). Specifically, nodes disposed in a predetermined region exchange messages in order to find neighboring nodes when power is on. In this case, each node exchanges the message with neighboring node by including its own residual energy in the message. As a result, after each node finds the neighboring node, each node generates a neighboring node management table including a residual energy field for the neighboring nod.

The node selects a neighboring node having the largest residual energy on the basis of the residual energy as a candidate head node from the generated neighboring node management table (S420).

Meanwhile, the node determines whether its residual energy is larger than the residual energy of the candidate head node (S430).

If its residual energy is larger than that of the candidate head node (S430-Y), the node determines itself as a final head node (S440) and broadcasts a final head node message which is a message indicating that the node itself is the final head node (S450).

However, if its residual energy is not larger than that of the candidate head node (S430-N), the node determines whether the node receives the final head node message from the candidate head node within a predetermined time (S460).

If the node receives the final head node message from the candidate head node within the predetermined time (S460-Y), the node determines the candidate head node as the final head node (S470).

However, if the node does not receive the final head node from the candidate head node within the predetermined time (S460-N), the node determines the candidate head node as a relay node (S480).

Clustering is performed on the basis of the determined final head node.

In the exemplary embodiment, the node's own residual energy is not included in the neighboring node management table, but the present invention is not limited thereto. The node may determine the candidate head node by including the node's own residual energy in the neighboring node management table. In this case, steps S420 and S430 are integrated as one step.

As described above, it is possible to minimize a clustering process time required to configure the clustering by determining a head node. It is possible to ensure the time required for main operations such as actual monitoring, and the like in large-scale wireless sensor networks by saving the clustering process time to improve efficiency.

Although exemplary embodiments of the present invention have been illustrated and described, the present invention is not limited to the above-mentioned embodiments and various modifications can be made by those skilled in the art without the scope of the appended claims of the present invention. In addition, these modified embodiments should not be appreciated separately from technical spirits or prospects.

What is claimed is:

1. A method of determining a head node for clustering in a wireless sensor network constituted by a plurality of nodes, the method comprising:
generating, by at least one node among the plurality of nodes, a neighboring node management table including residual energy of neighboring nodes by being in communication with the neighboring nodes;
selecting, by the node, a node having the largest residual energy as a candidate head node from the neighboring node management table;
determining, by the node, receiving a final head node message indicating that the node itself is a final head node from the candidate head node within a predetermined time; and
determining the candidate head node as the final head node or a relay node on the basis of the determination result.

2. The method of claim 1, wherein the determining includes:
determining the candidate head node as the final head node when the final head node message is received from the candidate head node within the predetermined time; and
determining the candidate head node as the relay node when the final head node message is not received from the candidate head node within the predetermined time.

3. The method of claim 1, wherein the neighboring node management table includes information regarding the neighboring nodes and information about the residual energy of the neighboring nodes.

4. The method of claim 1, wherein the neighboring node management table includes information about the node itself and information about the node's own residual energy.

5. A method of determining a head node for clustering in a wireless sensor network constituted by a plurality of nodes, the method comprising:
acquiring, by a first node among the plurality of nodes, residual energy information of neighboring nodes by being in communication with the neighboring nodes;
determining, by the first node, itself as a head node if the residual energy of the first node is larger than the residual energy of the neighboring nodes; and
broadcasting, by the first node, a final head node message indicating that the first node itself is the head node to the neighboring nodes.

6. The method of claim 5, further comprising determining, by the second node, the neighboring node having the largest residual energy as a final head node when a second node among the plurality of nodes receives the final head node message from a neighboring node having the largest residual energy within a predetermined time.

7. The method of claim 5, further comprising determining, by the second node, the neighboring node having the largest residual energy as a relay node when the second node among the plurality of nodes does not receive the final head node message from the neighboring node having the largest residual energy within the predetermined time.

8. A wireless sensor network, comprising:
a first node; and
at least one neighboring node wirelessly being in communication with the first node,
wherein the first node selects a node having the largest residual energy among the neighboring nodes as a candidate head node and determines the candidate head node as a final head node or a relay node by determining whether the first node receives a final head node message indicating that the candidate head node is the final head node from the candidate head node within a predetermined time.

9. The wireless sensor network of claim 8, wherein the first node determines the candidate head node as the final head node when the first node receives the final head node message from the candidate head node within the predetermined time, and determines the candidate head node as the relay node when the first node does not receive the final head node message from the candidate head node within the predetermined time.

10. The wireless sensor network of claim 8, wherein the first node generates a neighboring node management table including the residual energy of the neighboring nodes by being in communication with the neighboring nodes.

11. A wireless sensor network, comprising:
a first node; and
a second node wirelessly being in communication with the first node,
wherein the first node broadcasts a final head node message which is a message indicating that the first node itself is a final head node to the second node if the residual energy of the first node is larger than the residual energy of the neighboring nodes.

12. The wireless sensor network of claim 11, wherein the second node determines the first node as the final head node when the second node receives the final head node message from the first node within a predetermined time.

13. The wireless sensor network of claim 11, further comprising:
a third node wireless being in communication with the second node,
wherein the third node determines that the second node is a node having the largest residual energy among neighboring nodes of the third node, but the third node determines the second node as a relay node when the third node does not receive the final head node message from the second node within a predetermined time.
